(19) United States
(12) Patent Application Publication
(10) Pub. No.: US 2008/0138165 A1
(43) Pub. Date: Jun. 12, 2008

(54) DRILL BIT

(76) Inventor: Laverne Durfee, Harmony, NC (US)

Correspondence Address: Dennis J. Williamson;Moore & Van Allen, PLLC, P. O. Box 13706, Research Triangle Park, NC, 27709, US

(21) Appl. No.: 11/567,355

(22) Filed: Dec. 6, 2006

(51) Int. Cl. B23B 51/02

(52) U.S. Cl. 408/230

(57) ABSTRACT

A drill bit comprises a shank defining a longitudinal axis. Three ribs extend in a curve about the longitudinal axis. The ribs include side edges extending for a first portion at a first angle relative to the longitudinal axis and for a second portion at a second angle relative to the longitudinal axis. A lead screw extends along the longitudinal axis and has threads extending at a thread angle. A cutting edge is formed along the edge of each of the ribs. The cutting edge has a bevel angle where the thread angle is less than the bevel angle.

The invention relates generally to boring tools and more particularly to an improved drill bit.

### BACKGROUND OF THE INVENTION

Rotary drill bits for boring holes of preselected diameters in a workpiece are known. Such bits come in a variety of styles such as augers, spade bits, twist bits, and the like. One type of bit is known as a wood auger bit. This type of bit includes a shank that has one end adapted to be connected to a chuck of a rotary tool such as a drill or driver. The opposite end of the shank supports a wood auger that comprises a flute that terminates in a cutting face for cutting a bore in the workpiece. The cutting member may also be formed with a pilot point along its longitudinal axis for guiding the bit into and through the workpiece. Another type of bit is known as a spade bit or paddle bit. This type of bit includes a shank that has one end adapted to be releasably connected to a chuck of a rotary tool such as a drill or driver. The opposite end of the shank supports a cutting member where the cutting member has a substantially flat, relatively thin face formed as a paddle or spade. Twist bits comprise a shank having a cutting member supported on one end thereof. A pair of helical flutes extend around the longitudinal axis of the bit for a plurality of turns.

While such drill bits are known a wood bit that efficiently bores a clean, fast hole is desired.

### SUMMARY OF THE INVENTION

A drill bit comprises a shank defining a longitudinal axis. Three ribs extend in a curve about the longitudinal axis, the ribs include side edges extending for a first portion at a first angle relative to the longitudinal axis and for a second portion at a second angle relative to the longitudinal axis. A cutting edge formed along the edge of each of the ribs.

A drill bit comprises a shank defining a longitudinal axis. A lead screw extends along the longitudinal axis and has threads extending at a thread angle. Three ribs extend in a curve about the longitudinal axis and a cutting edge is formed along the edge of each of the ribs. The cutting edge has a bevel angle. The thread angle is less than said bevel angle.

A drill bit comprises a shank defining a longitudinal axis. A lead screw extends along the longitudinal axis and has threads extending at a first angle relative to the longitudinal axis. Three ribs extend in a curve about the longitudinal axis and a cutting edge is formed along the edge of each of the ribs. The cutting edge has an included angle of between 25 and 65 degrees and a bevel angle of between 10 and 20 degrees.

### BRIEF DESCRIPTION OF THE DRAWINGS

FIG. 1 is a side view of one embodiment of the drill bit of the invention.

FIG. 2 is an end view of the drill bit of FIG. 1.

FIG. 3 is a partial section view taken along line 3-3 of FIG. 2.

FIG. 4 is a detailed view of the lead screw of the invention.

### DETAILED DESCRIPTION OF EMBODIMENTS OF THE INVENTION

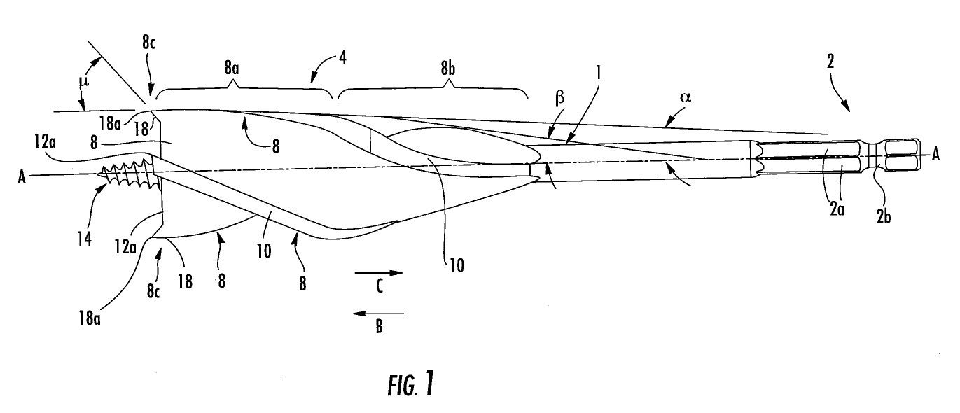

Referring to FIG. 1 the drill bit of the invention consists of a longitudinally extending shank 1 that may have a quick connect coupling 2 at one end thereof for connecting the drill bit to a rotary tool such as a drill, power driver or the like. The quick connect coupling as shown includes a plurality of flat surfaces 2a arranged at one end of shank 1 and adapted to be received in the chuck of the rotary driver. A circumferentially extending groove 2b extends around the shank 1 and may be releasably connected to the quick release coupling of the rotary tool. Other mechanisms for connecting the drill bit 1 to a rotary driver may also be used.

Referring to FIGS. 1 and 2 a cutting head 4 is supported at the opposite end of the shank 1 from quick connect coupling 2. The shank 1 and cutting head 4 may be formed of high strength material such as heat treated carbon steel. The cutting head 4 is formed of three flutes 6 that extend in a generally helical shape about the longitudinal axis A-A of the drill bit. The flutes 6 form three ribs 8 that terminate in side edges 10. The ribs 8 extend for a twist angle φ of between approximately 115 and 125 degrees with a preferred angle of approximately 120 degrees. The twist angle φ is the angle between the leading edge of a face of a rib and the trailing edge of the same face. Each of the ribs 8 extend in a curve around the longitudinal axis A-A in a generally helical shape.

The ribs include first portions 8a that extend from the distal ends 8c of the ribs 8 for a first portion of the cutting head 4. In the illustrated embodiment the first portions 8a extend for approximately half of the cutting head 4 and provide bearing surfaces for maintaining the drill bit centered in the bore being drilled and preventing the drill bit from wandering as the bore is drilled. In order to provide clearance between the bit and the wall of the bore, the first portions 8a of ribs 8 extend at an angle α of between 2 minutes and 2 degrees to the longitudinal axis A-A of the bit such that the ribs narrow as the ribs extend from the distal ends 8c toward the shank 1. In one preferred embodiment angle α is approximately 1 degree.

The ribs 8 include second portions 8b that extend from the first portions 8a to the shank 1. The second portions extend at an angle β of between 10 and 35 degrees to the longitudinal axis A-A of the bit such that the ribs narrow as the ribs extend from the first portions 8a toward the shank 1. In one embodiment angle β is approximately 14 degrees. As a result, the ribs 8 taper more aggressively as the ribs extend toward shank 1. This taper is provided as a rescue feature to better allow the drill bit to be removed from a deep bore as will hereinafter be described.

When a drill bit is used to drill a deep bore the drill bit may become lodged in the bore. This can result from the drill bit hitting an obstruction where its movement is blocked, damage to the drill bit such as a broken lead screw, binding of the bit caused by swarf and chips in the bore or the like. In a deep bore the swarf and chips that build up over the top of the bit can actually make removal of the bit difficult or impossible where the bit binds or otherwise cannot move forward. In such a situation, to remove the drill bit from the bore, the rotation of the bit is reversed such that the ribs 8 will pull the swarf and chips that are on top of the bit through the bit in the direction of arrow B to clear the bore and allow removal of the bit from the bore in the direction of arrow C. The aggressive angle of the second portions 8b of the ribs 8 allow the ribs to more easily penetrate the chips and swarf to facilitate clearing of the bore.

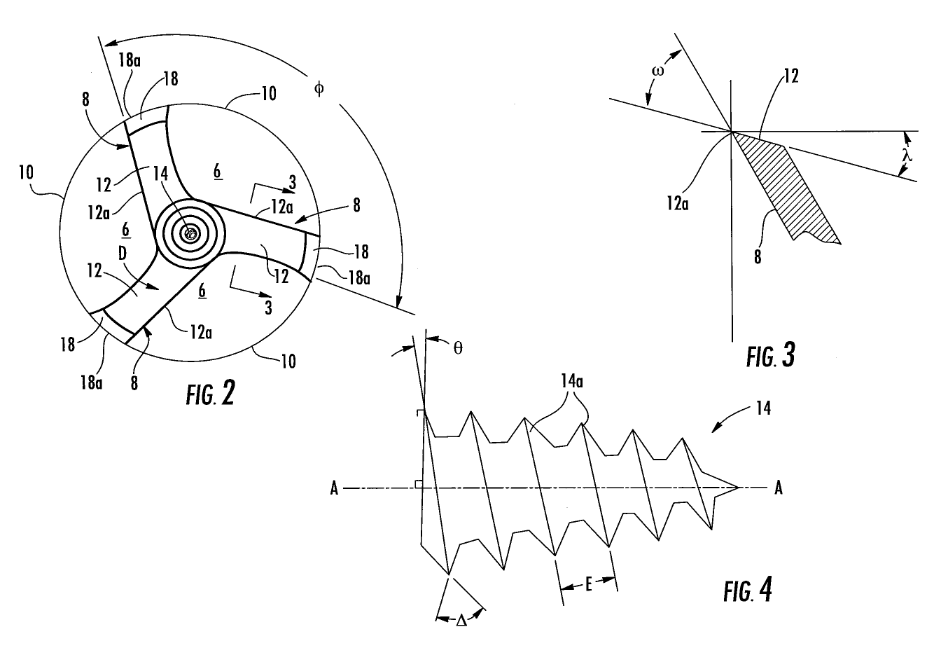

A cutting face 12 is formed at the distal ends 8c of ribs 8 between each side edge 10 and the pilot screw 14. Each cutting face 12 is formed with a bevel angled of between 10 and 20 degrees with a preferred angle of approximately 12 degrees relative to a line perpendicular to the longitudinal axis A-A to create sharp cutting edges 12a having an included angle ω as best shown in FIG. 3. Included angle ω may be between 25 and 65 degrees with a preferred angle of approximately 52 degrees. Cutting edges 12a contact the material being cut as the drill bit is rotated in the direction of arrow D to shave off a portion of the material and create a cylindrical bore.

Each cutting face 12 is formed at its outer edge with a spur 18 that scribe a smooth edge on the bore being drilled. Each spur 18 may be formed by extending the side edge 10 of rib 8 past the cutting face 12 and creating a sharp cutting edge 18a. In one embodiment the cutting edge 18a is formed with an included angle μ of between approximately 48 and 52 degrees with a preferred angle of 50 degrees as shown in FIG. 1.

Referring to FIGS. 1 and 4, the pilot screw 14 is formed as a threaded tapered screw that extends along the longitudinal axis A-A of the bit. The threads 14a have an included angle Δ of approximately 40 degrees. The pitch E of the threads is between approximately 1.00 and 2.5 millimeters. The angle θ of the threads with respect to a line perpendicular to the longitudinal axis A-A of the threads is a function of the combination of a fixed pitch and the increasing diameter of the tapered pilot screw 14. The angle θ is measured at the largest diameter of the tapered pilot screw 14 and may be between 4 and 20 degrees with a preferred angle of approximately 8 degrees. In one embodiment the angle θ is less than the angle λ forming the cutting edges 12a and in one preferred embodiment the angle θ is 4 degrees less than the angle λ forming the cutting edges 12a.

By using in different combinations a relatively flat bevel angle A, a bevel angle A that is greater than the thread angle θ of pilot screw 14, and three ribs with three cutting edges 12a, the drill bit shaves off relatively thin pieces of the workpiece as opposed to the relatively large chunks of workpieces cut by traditional wood augers and spade bits. As a result, the swarf created by the bit has a particle size that is relatively smaller and lighter than with known wood augers and spade bits such that the swarf is easier to eject from the bore during drilling such that the drill bit provides increase drilling speeds and uses less power than common wood bits.

While embodiments of the invention are disclosed herein, various changes and modifications can be made without departing from the spirit and scope of the invention. One of ordinary skill in the art will recognize that the invention has other applications in other environments. Many embodiments are possible. The following claims are in no way intended to limit the scope of the invention to the specific embodiments described above.

1. A drill bit comprising:
a shank defining a longitudinal axis;
three ribs extending in a curve about the longitudinal axis, said ribs including side edges extending for a first portion at a first angle relative to the longitudinal axis and said ribs extending for a second portion at a second angle relative to the longitudinal axis;
a cutting edge formed along the edge of each of the ribs.

2. The drill bit of claim 1 wherein the second angle is greater than the first angle.

3. The drill bit of claim 1 wherein the ribs narrow in first portion from the distal end of the ribs toward the shank.

4. The drill bit of claim 1 wherein the ribs narrow in the second portion from the first portion toward the shank.

5. The drill bit of claim 1 wherein the second portion extends from the first portion to the shank.

6. The drill bit of claim 1 wherein the first angle is between 2 minutes and 2 degrees.

7. The drill bit of claim 1 wherein the first angle is approximately 1 degree.

8. The drill bit of claim 1 wherein the second angle is between 10 and 35 degrees.

9. The drill bit of claim 1 wherein the second angle is approximately 14 degrees.

10. The drill bit of claim 1 where the ribs extend through a twist angle of between approximately 115 and 125 degrees.

11. A drill bit comprising:
a shank defining a longitudinal axis;
a lead screw extending along said longitudinal axis having threads extending at a thread angle; and
three ribs extending in a curve about the longitudinal axis and a cutting edge formed along the edge of each of the ribs, said cutting edge having a bevel angle where said thread angle is less than said bevel angle.

12. The drill bit of claim 11 wherein the lead screw has a pitch of between 1.0 and 2.5 millimeters.

13. The drill bit of claim 11 wherein said thread angle is approximately between 4 and 20 degrees.

14. The drill bit of claim 11 wherein said thread angle is approximately 8 degrees.

15. The drill bit of claim 11 wherein said bevel angle is approximately between 10 and 20 degrees.

16. The drill bit of claim 11 wherein said bevel angle is approximately 12 degrees.

17. The drill bit of claim 11 wherein said cutting edge has an included angle of between 25 and 65 degrees.

18. The drill bit of claim 11 wherein said thread angle is an angle between a thread and a line perpendicular to the longitudinal axis.

19. The drill bit of claim 11 wherein said bevel angle is an angle between the a cutting face defining the cutting edge and a line perpendicular to the longitudinal axis.

20. A drill bit comprising:
a shank defining a longitudinal axis;
a lead screw extending along said longitudinal axis having threads extending at a first angle relative to the longitudinal axis;
three ribs extending in a curve about the longitudinal axis and a cutting edge formed along the edge of each of the ribs, said cutting edge having an included angle of between 25 and 65 degrees and a bevel angle of between 10 and 20 degrees.

21. A drill bit comprising:
a shank defining a longitudinal axis;
three ribs extending in a curve about the longitudinal axis, said ribs including side edges extending for a first portion at a first angle relative to the longitudinal axis and said ribs extending for a second portion at a second angle relative to the longitudinal axis;
a lead screw extending along said longitudinal axis and having threads extending at a thread angle;
a cutting edge formed along the edge of each of the ribs, said cutting edge having a bevel angle where said thread angle is less than said bevel angle.
